(19) United States
(12) Patent Application Publication
(10) Pub. No.: US 2002/0178019 A1
(43) Pub. Date: Nov. 28, 2002

(54) Method and apparatus for message escalation by digital assistants

(76) Inventors: Andrew V. Anderson, Hillsboro, OR (US); Paul R. Pierce, Portland, OR (US); Uttam Sengupta, Portland, OR (US); Ticky Thakkar, Portland, OR (US); Kit Tham, Portland, OR (US); Nick Wade, Portland, OR (US); Trevor Pering, Mountain View, CA (US); Steve Bennett, Hillsboro, OR (US); Lee Hirsch, Cupertino, CA (US); Scott Robinson, Portland, OR (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/895,557

(22) Filed: Jun. 29, 2001

Related U.S. Application Data
(63) Continuation-in-part of application No. 09/865,919, filed on May 24, 2001.

(51) Int. Cl. G06F 17/60

(52) U.S. Cl. 705/1

(57) ABSTRACT

A method and apparatus for taking action in response to an event without contacting at least one person if the level of importance of the event to a first person meets or exceeds one threshold, but is below or only meeting another threshold.

### FIELD OF THE INVENTION

The present invention is related to an apparatus and method for escalating messages to individuals by way of digital assistants, such as pagers, telephones and organizers.

### ART BACKGROUND

Electronic devices and services used to retrieve information and provide reminders of appointments are widely known.

Commonly available PDAs (“personal data assistants”) and other devices allow users to store and organize information concerning people, places and events are currently in wide use. Many such devices maintain a user's schedule and provide automated reminder functions to remind the user of an upcoming event, such as a meeting. However, these devices require that all such information be directly supplied by their users. In essence, these devices do nothing beyond what their users instruct them to do.

Commercial services to provide meeting reminders and notices of events tailored to the individual interests of subscribers are also available. Many such services provide various ways in which a subscriber can provide a list of categories of information that the subscriber wants to be informed about. However, these services require the subscriber to specify the categories or other criteria concerning the information the subscriber is interested in. In essence, these services also do nothing beyond what their users instruct them to do.

There exist commercial paging services by which a subscriber may arrange to have results of sporting events, weather reports, or notices of favorable conditions for surfing sent to a pager. Additionally, there are commercial services whereby a subscriber may arrange to receive a “wake up” call on their home telephone (or at some other telephone number) at a specified time on a given morning. However, these services are limited to contacting a subscriber by a single method prescribed by a user and for a single purpose.

Furthermore, there exists a feature in various pieces of software by which a user may be informed by email of a change made to an item under the user's control in a database or in a piece of programming code for which the user is responsible. However, this entails the use of a very limited option for contacting a user for very limited reasons.

### BRIEF DESCRIPTION OF THE DRAWINGS

The objects, features, and advantages of the present invention will be apparent to one skilled in the art in view of the following detailed description in which:

FIG. 1 is a block diagram of one embodiment of the present invention.

FIG. 2 is a flow chart followed by one embodiment of the present invention.

FIG. 3 is a flow chart followed by another embodiment of the present invention.

FIG. 4 is a flow chart followed by another embodiment of the present invention.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention.

The present invention concerns the escalating of selected information to the user of an automated assistant. Such escalation of selected information to a user could be done through portable or hand-held devices such as pagers, PDAs, mobile telephones or portable computers to keep the user up to date concerning his personal schedule. However, as those skilled in the art will appreciate, the present invention is also applicable to the use of non-portable devices such as stationary computer systems or landline telephones, and may be used to provide information concerning issues other than personal schedule, such as current events, or affairs involving other people with some importance or connection to a user.

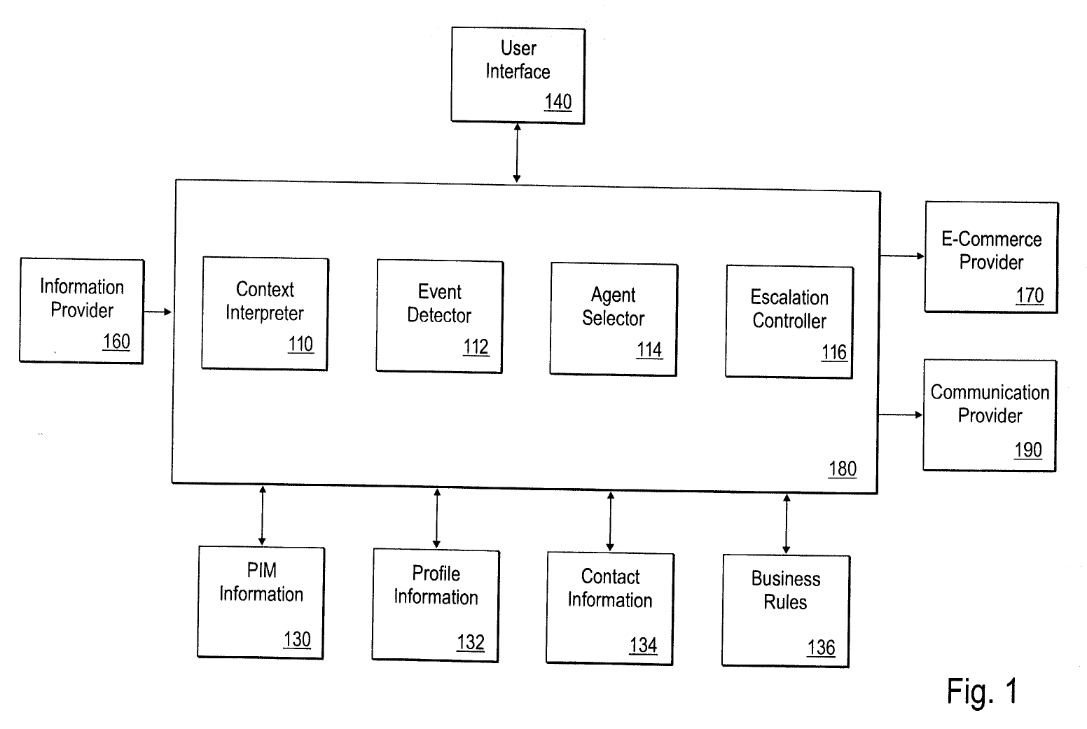

FIG. 1 is a block diagram of one embodiment of the present invention. Automated assistant 100 is comprised of context interpreter 110, event detector 112, agent selector 114 and escalation controller 116. Automated assistant 100 relies on various pieces of information concerning a user including, but not limited to, PIM information 130, profile information 132, contact information 134 and rules 136. User interface 140 allows a user to customize automated assistant 100. Automated assistant 100 receives information that may be of importance to a user from at least one information provider 160, and automated assistant 100 may interact with at least one ecommerce provider 170 in order to carry out instructions from a user. At least one communication provider 190 is used by automated assistant 100 to provide remote communication with a user. In one embodiment, such communication may include access to user interface 140.

In one embodiment, user interface 140 is an application run by a user on a computer system, cell phone, portable PDA or other device used to gain access to automated assistant 100 and/or to modify information used by automated assistant 100. In another embodiment, user interface 140 may be presented by way of web pages allowing a user to modify information used by automated assistant 100, and viewable using commonly available web browser hardware and/or software. In yet another embodiment, user interface 140 is accessible only to a service provider that provides either part or all of the services of automated assistant 100 to a user. In various embodiments, a user's interaction with automated assistant 100 may be through communication provider 190.

PIM information 130 is maintained by automated assistant 100 and is comprised of daily information concerning a user. In one embodiment, this information includes, but is not limited to, the kinds of information often maintained on currently available PDA devices, such as a calendar of scheduled events and appointments, an address list, a phone list and memos by the user such as a “to-do” list. In one embodiment, this information is updated on a recurring basis from a PDA device carried by a user. In another embodiment, this information is provided by the user through use of user interface 140. In yet another embodiment, the user provides this information to automated assistant 100, directly through such devices as a pager or mobile phone. In still another embodiment, PIM information 130 additionally includes information concerning another person to whom a user may have delegated the authority to respond to one more types of events. In a further embodiment, PIM information 130 may be compiled from personal information maintained by other external sources, such as personal, work and/or family calendars maintained externally from automated assistant 100, but to which automated assistant 100 has access by any of a number of means. For example, PIM information 130 may contain some information concerning the schedule of that other person for use in determining whether or not that other person is available in lieu of the user at a given time.

Profile information 132 is maintained by automated assistant 100 and is comprised of information concerning a user's preferences. Such information could include, but is not limited to, e-commerce providers that a user prefers to use for particular products or services, whether the user prefers a window or aisle seat on an airplane, a user's tastes in food, a user's membership in frequent flier mileage programs or business rate rental car programs, whether a user prefers to make all travel arrangements or is willing allow that to be done by others, a user's preference for primary means of communication, a user's preferred commute routes, as well as which stocks or travel locations are of greatest interest to a user. Such information might also include, preferences about circumstances or types of events where a user prefers that another person be contacted in lieu of the user, such as a secretary, friend or family member of the user. In one embodiment, a user would provide such information to automated assistant 100, directly, possibly via user interface 140. In another embodiment, automated assistant 100 would derive such information by observing a user's behavior over time. In still another embodiment, a user would directly supply such information, but over time, automated assistant 100 would record the degree to which the user did or did not adhere to that supplied information.

Contact information 134 is maintained by automated assistant 100 and is comprised of information concerning what means are available to contact a user. In one embodiment, such information would comprise phone numbers for a user's pager, mobile phone, home telephone and/or business telephone, along with data concerning whether text messages can be received on a user's pager or mobile phone. In another embodiment, such information would comprise email addresses by which a user could be contacted. In yet another embodiment, such information would comprise phone numbers of places outside of work or home where a user could be found. In still other embodiments, contact information 134 may further comprise contact information on other individuals to which a user has given authority to handle one or more events in lieu of the user, such as secretaries, friends or family members of the user.

Rules 136 is maintained by automated assistant 100 and is comprised of a set of rules that must be followed in carrying out various functions. In various embodiments, such information would be supplied by the user and/or others to whom the user has given authority to add or edit rules, including but not limited to, those who are setting up or maintaining automated assistant 100, the user's employer, members of the user's family, etc. Also, in various embodiments, the rules would comprise, but not be limited to, limits on how much money may be spent on carrying out certain functions without first obtaining the user's approval, steps that must be followed in making reservations for travel or lodging, limits on the manner in which certain devices may be used in efforts to reach the user, limits concerning times during the day when the user does not want to be bothered, circumstances in which not the user, but another person to whom the user may have given authority to deal with one or more certain events, as well as exceptions to one or more of such rules. There may also be rules concerning which kinds of events or which subjects to which an event may pertain are too sensitive to permit contacting certain persons and/or to permit attempting to make contact by certain means that are somehow not deemed to be secure enough. In If the user does not specify others to whom authority to deal with one or more events has been delegated, there may be rules and/or heuristic algorithms defined to look at “buddy” lists, contact information, calendar information and/or other information to identify potential persons to whom such authority could be delegated. Rules 136 may be provided by various persons and/or entities such as a user, the designers or maintainers of automated assistant 100, an entity associated with a user (such as a user's employer), or others to whom a user has delegated authority to make or alter rules 136.

Context interpreter 110 tracks information and makes predictions concerning the current circumstances of a user, i.e., a user's context. Context interpreter 110 uses calendar, preference, profile, location and history information from various sources including, but not limited to, PIM information 130, profile information 132 and/or rules 136 to determine where a user is likely to be, what the user is likely to be doing, how available the user is likely to be to various persons and/or what resources are available for communication with the user. Where insufficient information is available to determine aspects of a user's context with certainty, predictions may be made, and such predictions may be accompanied by a confidence value to indicate the degree of certainty. In one embodiment, context interpreter 110 is an expert system which applies rules (which may or may not be part of rules 136) to make predictions concerning a user's context. In such an embodiment, a limit may be placed on the computations required to be performed by context interpreter 110 by limiting fields of information used in such computations to only those requested by other components of automated assistant 100.

Specifically, part of the information tracked by context interpreter are the activities and/or current whereabouts of a user. In one embodiment, context interpreter uses the calendar being maintained as part of PIM information 130 to track the user, relying on the assumption that the user will generally follow what is scheduled on that calendar. In another embodiment, context interpreter 110 uses information received through a communications provider 190 (discussed in greater detail, below) to track the actual activities and/or whereabouts of a user. Such information may be supplied by one or more devices being carried by a user, such as GPS data from a GPS receiver integrated into a user's cell phone or PDA. Such information may also be derived from wireless or landline-based voice or data networks, such as the broadcasting and receiving network of a cellular communications system, or a network address of where a user has currently attached a device such as a portable computer.

Event detector 112 receives both information from information provider 160 concerning events and input from context interpreter 110 as to where a user is currently located or what a user is currently doing and will be doing in the future, and uses that information, along with profile information 132 and/or rules 136, to make a determination as to what action, if any, should be taken in response. In other words, event detector 112 evaluates the importance of an event to determine if anything should be done in response. In determining the importance of an event to a user, event detector 112 examines the information received from information provider 160 to see if there are any indications of anything that might effect the activities that a user is currently engaged in, or will be engaged in, such as attending a meeting or making investments. Event detector 112 also examines the information received to determine if there is something that has happened or will be happening that may cause the user to want to add an activity, such as attending a convention concerning a subject of interest to the user. Furthermore, in determining the importance of an event to a user, event detector 112 also evaluates the urgency with which action is to be taken, possibly to avoid the loss of an opportunity to act and/or to enable an action to have greater beneficial effect.

Information provider 160 gathers and formats information for use by automated assistant 100. In various embodiments, the information received from information provider 160 could comprise weather updates, traffic reports, and news of such events as sales or special local events that may be of interest to a user engaged in local activities. In other embodiments, the information received could comprise flight arrival and departure schedules, flight status, weather conditions at distant locations and along routes of travel, and the occurrence of major events at distant locations that may be of interest or have an impact on the travel plans of a traveling user. In still other embodiments, the information received could comprise stock quotes, earnings reports by corporations, and announcements by government agencies or other institutions of interest to a user engaged in making investments. Information provider 160 may be an original source for information about events and/or a gatherer and formatter of information about events received from other entities such as government agencies (e.g., NOAA) or commercial entities (e.g., CNN or MapQuest) where information provider 160 extracts, summarizes or transcodes information as necessary.

In one embodiment, event detector 112 would use information from context interpreter 110 concerning a user's context to classify events as either scheduled and unscheduled. Part of this classification would rely on making a determination as to whether or not an event represents a deviation from a norm, which may be represented as a threshold value beyond which an event is considered to be outside the norm. Alternatively, information concerning whether an event is outside the norm (i.e., whether an event is in some way an “exception”) may be provided as part of other information concerning the event from an external source, such as information provider 160. An example of a scheduled event may be the checking of a weather information feed on a period basis. Another example would be the passage of time triggering a reminder of an event that was earlier scheduled on a calendar. Examples of unscheduled events may be the receipt of a new email or an alert from an airline about a flight cancellation.

If event detector 112 determines that an event has occurred that requires an action to be taken, then agent selector 114 receives indications from event detector 112 that an event of interest to a user has occurred, along with an indication from event detector 112 of the degree to which the event is of importance to the user. Taking into account the nature of the event and the degree of interest to the user, agent selector 114 determines whether the user should be contacted, whether another person that the user has given authority to handle certain events on the user's behalf should be contacted, whether multiple persons should be simultaneously contacted, or whether automated assistant 100 could independently take action that would be sufficient without disturbing the user. In making this determination of which persons to contact, agent selector may refer to profile information 132 and/or rules 136 for restrictions supplied by the user and/or others concerning who should be contacted for particular events and under what circumstances, as well as any applicable exceptions.

If it is determined that the user and/or others must be contacted, then agent selector 114 uses contact information 134 and the degree of interest to the user indicated by event detector 112 to select the means by which the user and/or others must be informed. If the event is of sufficient importance that immediate action is required, but the user has indicated that a person and not automated assistant 100 must take that action, then agent selector 114 may determine that the user or a person specified by the user should be contacted via multiple means, simultaneously. For such an important event, agent selector 114 may determine that multiple persons should be contacted simultaneously, and those persons may or may not include the user.

In selecting a means by which the user must be informed, agent selector 114 may take into account the different limits imposed by the different means by which the user may be informed. For example, the user may have a pager that may or may not be able to display text information to the user, and if the pager has text capability, then there may be limits on the number of characters that can be sent. Such limits on the pager may make it more desirable to contact the user by way of an available text-enabled cell phone, if the message that must be communicated is lengthy, and the text-enabled cell phone is able to accept and/or display a larger message. The nature of the message and the expected response from the user may also be taken into account. For instance if the message is a list of possible alternate flights to replace a cancelled flight, then any device which can display the alternatives and allow for simple selection may be used. If however, the event is one which will require a freeform response (e.g. a continuing e-mail exchange with an important contact), devices capable of such interaction would be preferred.

In still another embodiment, agent selector 114 may take into account information concerning a user's current location in selecting a means to contact a user, including information provided by context interpreter 110. Limits in geographic coverage may preclude the use of a user's pager, cell phone or other wireless device, and agent selector 114 may take this into account in choosing another means of contacting a user. There may be compatibility, security or protocol limits precluding the uses of a data network to reach a user by way of a portable computer or other device, even if that device is currently attached to a network and is, therefore, otherwise accessible. Such limits may be the result of a “firewall” limiting access to a private network to which a user has attached the device, which may happen in situations where a user is a guest visiting the place at which his device is attached to the private network. Another such limit may be imposed by limits in the wireless coverage available in a given geographical location, such that a user with a text-enabled cell phone nonetheless cannot receive text messages on his cell phone, because the wireless network in the user's current location does not support such a feature.

By way of example, if in one embodiment, a user was invited to attend a meeting, but opted not to do so, then there is no need for the user to be contacted if the meeting is later cancelled, because this event is of no importance to the user, and so agent selector 114 may simply send an acknowledgement to the sender of a note that the meeting was cancelled. However, if the user had chosen to attend the meeting, and it is later cancelled, then agent selector 114 would refer to contact information 134 to select a means of reaching the user to inform the user of the cancellation. If the meeting was scheduled to occur in the very near future, and so the cancellation is very much at the last minute, then agent selector 114 might use a means of reaching the user that would be more appropriate for providing the user with a swift notification of the cancellation, such as the user's pager or mobile phone. However, if the cancelled meeting was to occur quite some time later, then agent selector 114 may choose to send the user an email which the user can receive and read at leisure, or agent selector may choose to contact a person that the user has specified as someone to deal with such a situation on the user's behalf, such as a secretary, since this information is not so urgent.

In another embodiment, where agent selector 114 is selecting a means by which to contact a user, agent selector 114 refers to rules 136, as well as contact information 134, in making that selection. Although the user may need to be urgently contacted concerning an event, rules 136 may indicate that it is currently night time, and the user has specified that contact is to take place at night only under specific circumstances, and so agent selector 114 may wait until morning if the event does not fit those specific circumstances. In essence, agent selector 114 weighs the importance of contacting the user against the intrusion to the user of doing so, and chooses the appropriate time and means of contacting the user.

In still another embodiment the agent selector 114 contains a small number of templates in which events of a given type or severity are mapped to a specific defined action to be taken. Part of that defined action may be to contact one or more specific persons or contacts other than the user. Such specific persons might be emergency personnel or a user's secretary or administrative assistant. For example, in one embodiment, a template might specify that flight cancellations are to be handled only by the user—no other person, and not automated assistant 100. Or, in another example, a template might specify that flight cancellations will be assigned to an administrative assistant if more than a specified amount of time exists before the scheduled departure time.

An event may arise for which there is no template, but for which a person other than a user must be chosen and contacted. This may be the case either due to limitations imposed on contacting the user within rules 136 or other factors such as limits in means of communication by which a user may be reached. In one embodiment, a person chosen due to some connection with the user and the event in question would be contacted. Such a person may be someone that the user has met with, recently, or a person with whom the user regularly consults concerning events of the kind that has arisen, and who is therefore a person associated with the subject of the event, such as a financial advisor or broker in the case of an important event concerning the user's financial portfolio. If the event is an emergency concerning a family member or friend of the user, a person from the user's address book or buddy list may be selected. The selected person maybe someone that from scheduled events, seems to have a connection to the family member or friend who is the subject of the emergency, such as a baby sitter in the case of an emergency concerning one of the user's children.

If it was determined that an event required that a user be contacted, and contact was attempted by agent selector 114, but has been unsuccessful in reaching the user, then escalation controller 116 determines when and how to escalate the effort to contact the user. In one embodiment, escalation controller 116 monitors the initial effort made by agent selector 114 to contact the user via an initial choice of device, and if the attempt is unsuccessful after a certain period of time, escalation controller 116 prods agent selector 114 to try harder by making another attempt, and perhaps by using a different device. In another embodiment, escalation controller 116 may be combined with agent selector 114, and the combined agent selector and escalation controller may simply reevaluate the initial weighing of the importance of contracting the user against the intrusion of doing so, now that more time has passed, and the need to contact the user may have become more urgent.

By way of example, the user may have been scheduled to take a flight later in the day, but the flight has now been cancelled, and the user needs to be informed. From information found in the calendar maintained as part of PIM information 130, it may be determined that user is currently in a meeting, and from information found in rules 136, the user does not like to be disturbed during such a meeting. However, because the cancelled flight was to depart later that same day, perhaps even shortly after the meeting the user is currently attending, there is a need to contact the user during the meeting, in spite of the intrusiveness of doing so. In response, agent selector 114 refers to contact information 134, discovers that the user has a pager capable of receiving text messages, and sends the user a text message on the user's pager. However, for whatever reason, a reasonable period of time passes without the user having contacted automated assistant 100 to schedule a new flight or to abandon making the trip, altogether, and so escalation controller 116 prods agent selector 114 into trying harder. Agent selector 114 again reviews contact information 134 and rules 136 and determines that making an effort to reach the user by way of a speech-synthesized voice to the user's mobile phone is now appropriate, and does so. However, for whatever reason, the user does not answer, and so now agent selector 114 refers to PIM information 130 to obtain the telephone number of the conference room in which the user is scheduled to have a meeting (if that information is there), and places a call to that conference room. Many other scenarios are possible, and as those skilled in the art will understand, the above is but one example of how an event might be handled by an embodiment of the present invention.

Alternatively, in the case of some events, after one or more unsuccessful attempts to reach a user and/or another person, automated assistant 100 may simply handle the event, itself. It may be that the user has supplied a preference for having either the user or a specified person be the one to handle a given event, but then, if attempts at reaching the user and/or a specified person have proven unsuccessful, automated assistant 100 is to then handle the given event. In such an embodiment, where automated assistant 100 has handled an event, itself, automated assistant 100 may then later attempt to contact the same persons that automated assistant 100 had attempted to reach, earlier, to inform them that the event has been handled and/or to supply details of what the outcome of handling the event was. For instance, the event may be that a user's flight has been delayed, and attempts at reaching the user and/or the user's secretary have proven unsuccessful, and so automated assistant arranges for the prepaying of a fee necessary to guarantee a hotel room reservation for late check-in by the user.

An event may be ongoing in such a way that circumstances change to an extent that causes automated assistant 100 to repeatedly evaluate what course of action is to be taken or to reevaluate the question of whether action should be taken at all. The lack of response of a user as time passes, causing an event to become more urgent, and therefore more important, is one scenario. However, other scenarios such the receipt of additional information updating or correcting information received earlier about an event could be another frequently occurring scenario. Automated assistant 100 may change an earlier determination of who to contact or where to attempt contacting a person, in addition to determining what means to use in making such contact. Automated assistant 100 may initially determine that acting autonomously on behalf of a user is the best course of action and then later determine due to changing circumstances that a person must be contacted, or vice versa. In still another possible scenario, repeated efforts to contact one or more persons and/or efforts to take autonomous action may have failed to effectively deal with an event, and enough time may have passed during all of such efforts that any further effort would be futile. In such a scenario, escalation controllerll6 may cease attempting to prod agent selector 114 into taking any further action, and instead, may simply send a notice to the user of the actions attempted.

User interface 140 provides a user with a way to supply information needed to prepare automated assistant 100 for normal operation. In one embodiment, automated assistant 100 is maintained on centralized computer systems by a commercial provider of automated assistant 100 as a service to users to subscribe to, and an embodiment of user interface 140 could be a web page accessible to a user via the internet. In another embodiment, automated assistant 100 is maintained on a computer system owned by a user (or otherwise more locally accessible to a user), and user interface 140 could be an application that a user would run on that computer system.

Communication provider 190 allows automated assistant 100 to communicate with the external world. Communication provider 190 may be a commercial entity providing services used by automated assistant 100 in attempts that it may make to contact the user, and may be comprised of mobile phone service providers, paging service providers, internet service providers, etc. As discussed, earlier, in one embodiment, information concerning phone numbers or email addresses by which a user may be reached are maintained as part of contact information 134. Contact information 134 may also contain information about service charges and billing rates for each service provider 190, and such information may be among the factors weighed by either agent selector 114 or escalation controller 116 in determining when or how to contact a user. For instance, a user may have a satellite telephone by which the user could be reached in areas or at times when more conventional paging or mobile phone services are unavailable, but the need to reach the user in a particular instance may not be so pressing as to warrant incurring the high costs that might be associated with using such a recently developed means of contacting the user.

Alternatively, communication provider 190 may be comprised of hardware and/or software used to provide automated assistant 100 with access to devices such as facsimile machines, printers, mailers, scanners and other ways to interface with hardcopy communication channels. As still another possibility, communication provider 190 may be comprised of hardware and/or software to provide an interface to email, text-to-speech output, speech recognition input, or text messaging on such devices as pagers or other portable radio devices, etc.

Automated assistant 100 may also rely on communications provider 190 to supply information indicating a user's current whereabouts, either for use in updating a user's schedule, or as part of the information used in making a determination as to whether or not a user should be contacted concerning a given event. Where communications provider 190 provides wireless services, it may be possible for communications provider 190 to determine where a user is located, geographically, through the wireless network operated by communication provider 190. This might be done by analyzing relative signal strengths at different geographic points, or by identification of the geographic cell in which a user is operating a mobile phone, or by other means. It may also be the case that a user is carrying a cell phone, pager or other device able to provide information about the user's geographic location as determined by a GPS receiver or similar technology incorporated into the device, using the communications system provided by communications provider 190 as the vehicle to transmit that information.

E-commerce provider 170 may be the provider of such services as online shopping (i.e., shopping for goods or services over the internet or other electronic means), remote booking of travel services, calling in of food orders, etc. E-commerce provider 170 may be one avenue by which automated assistant 100 takes action autonomously in response to an event in addition to or in lieu of automated assistant 100 interacting with commercial or government entities on behalf of a user without the assistance of e-commerce provider 170. For example, if e-commerce provider 170 provides the ability to make or change flight reservations, then in the above example concerning a cancelled flight, automated assistant 100 could have simply made new flight arrangements on behalf of the user, perhaps also altering reservations for rental transportation and/or hotel accommodations. In one embodiment, whether or not automated assistant 100 would engage in making such arrangements on behalf of a user would depend on whether or not information within rules 136 indicates that the user is willing to allow automated assistant 100 to do so. It may be that the user wishes to make all arrangements and only wants automated assistant 100 to provide a warning of the need to do so. Alternatively, the user may be willing to let automated assistant 100 make such arrangements and then inform the user of the changes already made, but with a limitation on the highest price that the user is willing to allow automated assistant 100 to agree to on behalf of the user. E-commerce provider 170 includes, but is not limited to, entities with which automated assistant 100 could interact with by way of electronic messaging, e.g., emails, packetized electronic transfers, etc. E-commerce providers may even be individuals contacted by automated assistant 100 by analog land-line telephone and then spoken to by automated assistant 100 using text-to-speech technology.

FIG. 1, depicts an embodiment of an automated assistant in which various internal functions are partitioned and distributed in specific ways among the various components depicted. However, as will be apparent to one of ordinary skill in the art, the various internal functions may be partitioned differently among any of a number of components internal to automated assistant, as hereinafter claimed. Specifically, information concerning a user and/or other persons may be organized in a manner that varies from the aforedescribed divisions into PIM information 130, profile information 132, contact information 134 and rules 136. Furthermore, it may be that an automated assistant as hereinafter claimed may exist in a distributed form (not shown) with various internal functions performed by components maintained in different places or in different forms of software and/or hardware, and perhaps distributed among different commercial and/or governmental entities.

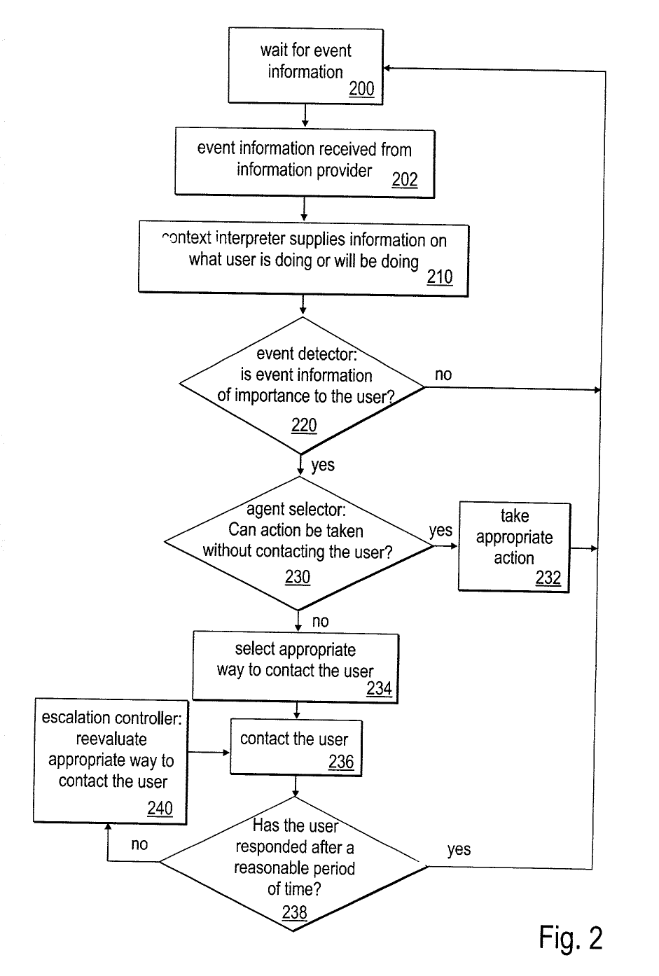

FIG. 2 is a flow chart followed by one embodiment of the present invention. A user's automated assistant waits for information concerning an event at 200. After event information is received at 202, the context interpreter of the automated assistant supplies information concerning what the user is doing now or what the user will be doing at 210. In one embodiment, the context interpreter retrieves this information from the user's calendar of scheduled events. In an alternate embodiment, the context interpreter retrieves this information from other sources that are able to supply an indication of what the user is currently doing or where the user is currently located.

At 220, the event detector of the automated assistant determines whether or not the event information is of importance to the user based on what the user is doing now or what the user will be doing, as well as based on what the user's interests are known to be from the user's profile information. If the event information is not of importance to the user, then the automated assistant takes no further action, and returns to waiting for event information at 200.

However, if the event information is of importance to the user, then the agent selector of the automated assistant determines whether or not the automated assistant can take appropriate action on its own, without having to contact the user. It might be appropriate for the automated assistant to act on its own, if the event concerns renewing a subscription or making an alteration in a reservation that the user would not have wanted to be bothered with. In one embodiment, the agent selector of the automated assistant would refer to the user's profile information to determine the user's preferences for whether or not the user would prefer to be involved in handling the event. In an alternate embodiment, the agent selector would refer to the rules information supplied by the user to see if there is a constraint on price amounts or a specific set of circumstances under which the user has specified that the user or another person acting on the user's behalf must be contacted which the event might meet. If the agent selector of the automated assistant determines that the event is one that the automated assistant can respond to without contacting the user, then the agent selector undertakes such action at 232.

However, if the agent selector of the automated assistant determines that the user must be contacted, then the agent selector refers to the user's contact information to determine the appropriate means for contacting the user. In one embodiment, the agent selector would also refer to the user's preferences for any indications of a preferred way in which the user would want to be contacted. In an alternate embodiment, the agent selector would also refer to the user's rules to determine if there are any requirements or limits supplied by the user concerning when or how the user may be contacted. For example, the user may have indicated a preference that the automated assistant contact the user on the user's text-enabled cell phone, but the user may have also supplied a rule that the user does not want to be called on his cell phone after a certain hour of the night, and that the user's text-enabled pager is always to be used after that hour. After selecting an appropriate way to contact the user at 234, the agent selector carries out contacting the user at 236.

If, at 238, the user has not responded, then at 240, the escalation controller of the automated assistant reevaluates the appropriate way to contact the user, taking into account any effect that the passage of time may have on how urgently the user needs to be contacted. It may be the case that the event is not something that needs to be responded to very urgently, and so the choice may be to try to contact the user, again, by the same means that were used to try and contact the user, originally. However, it may also be the case that the event is something that has become more urgent as a result of the passage of time, such as a change to a fast approaching, scheduled event in the user's calendar, and so the escalation controller may choose to use another means of contacting the user, one that may not have been what the user would have preferred, but which may now be necessary. In making this reevaluation, the escalation controller, like the agent selector, may refer variously to the user's preferences and/or the rules supplied by the user. At 236, another attempt would be made to contact the user, and again, the automated assistant would wait at 238 for an appropriate time for the user to respond before making further attempts.

However, if at 238, the user has responded to the initial attempt to contact the user, then the automated assistant returns to waiting for new event information at 200.

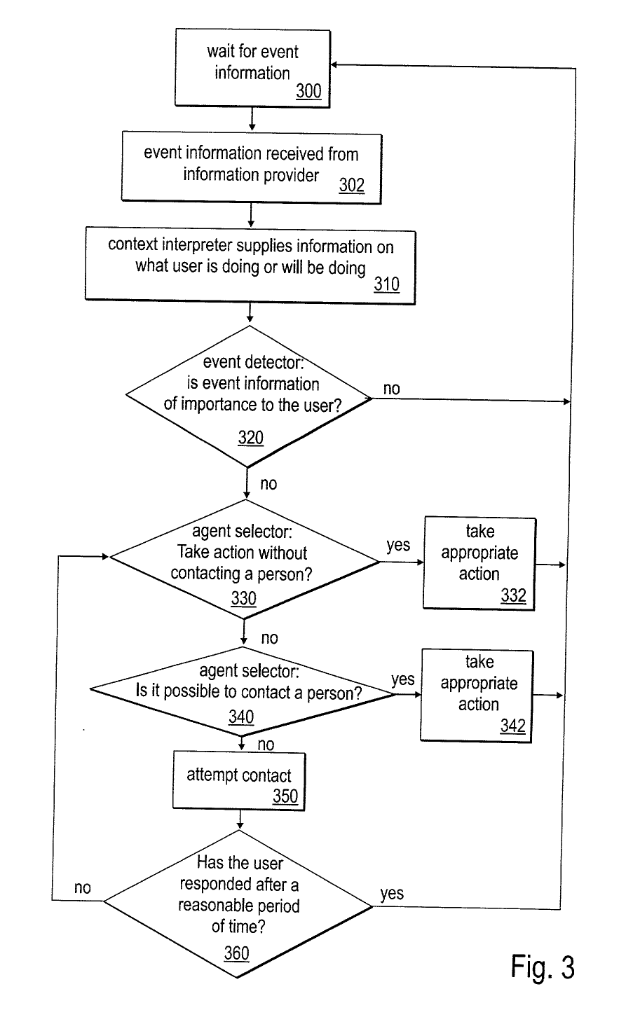

FIG. 3 is a flow chart of another embodiment of the present invention. In a manner corresponding to FIG. 2, a user's automated assistant waits for information concerning an event at 300. After event information is received at 302, the context interpreter of the automated assistant supplies information concerning what the user is doing now or what the user will be doing at 310. In one embodiment, the context interpreter retrieves this information from the user's calendar of scheduled events. In an alternate embodiment, the context interpreter retrieves this information from other sources that are able to supply an indication of what the user is currently doing or where the user is currently located.

At 320, the event detector of the automated assistant determines whether or not the event information is of importance to the user based on what the user is doing now or what the user will be doing, as well as based on what the user's interests are known to be from the user's profile information. If the event information is not of importance to the user, then the automated assistant takes no further action, and returns to waiting for event information at 300.

However, if the event information is of sufficient importance to the user, then at 330, the agent selector of the automate assistant determines whether or not the automated assistant should take appropriate action on its own without contacting anyone. It might be appropriate for the automated assistant to act on its own if the event concerns something minor that the user would not have wanted anyone to be bothered with, or if it is not possible to successfully contact anyone that would be appropriate to contact, at all, or within a period of time short enough to be useful. In various embodiments, the agent selector may use one or more pieces of information in making the determination of whether or not to contact someone and/or who, including the user's profile information, rules set by the user, various technological or geographical obstacles that may exist in trying to reach someone, and/or whether or not contact had been previously attempted, but was unsuccessful for either the current event or a previous event. If the agent selector determines that the event is one that the automated assistant can respond to without contacting the user, then the agent selector takes appropriate action at 332.

However, if at 330, the agent selector of the automated assistant determines that a person or persons must be contacted, then at 340, the agent selector determines what means to use in making contact, as well as whether or not it is actually possible to make contact. In making these determinations, various pieces of information may be used by the automated assistant, including, but not limited to the user's preferences, preferences of others if others are to be contacted in lieu of or in addition to the user, the schedules of the user and/or others, information concerning the various means available for reaching the user and/or others, information concerning the current whereabouts of the user and/or others, technological or geographic obstacles to reaching the user and/or others, and whether or not previous attempts to contact the user and/or others regarding this event or a previous event were successful. For instance, limits in wireless coverage at the current location of a person or the fact that the person is in transit, and therefore the person's location is constantly changing may impose limitations on the ways in which that person may be contacted. If it can be determined that a person to be contacted is currently stationary in an area with wireless coverage, then it may be desirable to send a text message to that person's pager or cell phone. Alternatively, if a person to be contacted is in motion, then communication by way of text messages may not be reliably available throughout that person's line of travel, and so it may be desirable to contact that person by their cell phone and place a voice message.

If the agent selector at 340 determines that it is possible to contact the user and/or another person or persons concerning the event, then the agent selector makes the attempt to do so at 350. Depending on the importance of the event or other information, the agent selector may attempt to reach multiple ones of the selected, concurrently. Also, in making the attempt, the agent selector may determine it is appropriate to contact one or more of the selected persons using more than one means of communication, concurrently.

At 360, if none of the persons contacted have responded within a reasonable period of time, then the escalation controller of the automated assistant prompts the agent selector to reevaluate what action is to be taken next, at 330. It may be that circumstances have changed with the passage of time incurred while waiting for someone to respond. It may no longer be necessary for anyone to be contacted, and therefore, the agent selector would take action as appropriate at 332. However, it may be that information such as the user's preferences indicates that it is not appropriate for the automated assistant to act on its own, and so at 340, a reevaluation is made by the agent selector as to whether or not it is still possible to try again to reach someone, and this may result in an attempt to make contact with a different person and/or with one or more of the same people previously tried, but with different means at 350. However, if at 340, it is determined that all avenues have been tried for reaching all of the appropriate people, then at 342, the agent selector takes whatever action is appropriate on its own. It should also be noted that depending on the time, circumstances and other information, the appropriate action taken by the automated assistant at 332 or 342 may be to take no action, at all. This may be because the user has indicated in preferences or in a template that no action is the correct choice, or circumstances may have changed since earlier attempts at contacting someone were made to such an extent that it the appropriate action has now become no action.

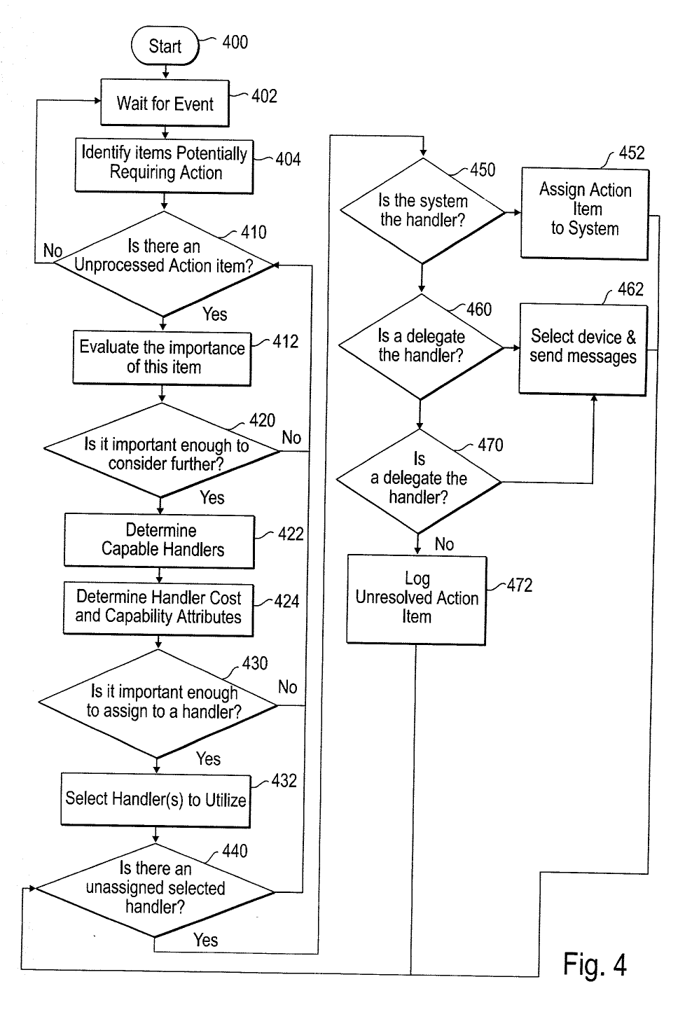

FIG. 4 is a flow chart of still another embodiment of the present invention. Starting at 400, a user's automated assistant waits for information concerning an event from information sources such as weather, traffic, flight status, emails, calendar reminders, etc., at 402. After event information is received, action items (tasks that need to be performed) in response to the event are identified at 404. If, at 410, it is determined that there is an action item that requires processing, then the importance of the action item is evaluated at 412. A single event may translate into a plurality of action items that may need to be carried out, such as a flight cancellation leading to an action item to notify the user, an action item to gather information on alternative flights for the user, and possibly an action item to proceed autonomously with booking an alternative flight for the user. In some embodiments, the identification of action items may be carried out in great detail, initially, while in other embodiments, only higher-level and more generalized tasks may be identified with the finer details being left to be determined at a later time by more specialized hardware and/or software either within or external to the automated assistant. In some implementations, this may mean that action items will only be identified when their dependencies have been met, while in other systems, action items will be identified sooner, but will not be acted upon until previous action items are completed or additional information needed to act on those action items becomes available.

At 420, an action item is evaluated to determine if it is of enough importance to take action. If not of enough importance, then the action item may not be processed, further, and another determination is made at 410 as to whether there are any more action items to be processed. In evaluating the degree of importance of an action item, various factors are weighed. The current activities and environment of the user are taken into account along with profile information, rules, passage of time and urgency of the action item and/or event are used. For example, an email received concerning a meeting requiring travel by a user to attend would have greater urgency for being acted on than an email concerning a meeting in the user's office, because changes resulting in the cancellation or rescheduling of a meeting may well entail canceling or rescheduling flights and/or hotel accommodations, and therefore, require some lead time to carry out, effectively. Another example of urgency playing a factor in determining importance is the difference between an event where notice is received of a flight cancellation 6 days in advance as opposed to 6 hours in advance. The latter case clearly requires action more urgently, and therefore is deemed more important. In contrast, the passage of time may make other events less important, rather than more important as the event becomes “stale,” such as an interest rate cut by the Federal Reserve Board, which may be an event creating an opportunity that may be of importance to a user, but only for a limited time, and may cease to be of value if the user and/or another person designated by the user does not respond in timely fashion.

If at 420, an action item is determined to be of enough importance to take action, then at 422, a determination is made to as to whether the user, a person delegated by the user, the automated assistant, or some combination of these are capable of handling the action item. In determining if the user is capable of handling the action item, various factors may be considered including, but not limited to, whether or not current information about the user's current location and activities (i.e., the user's context) indicates that the user can be reached via one of his communication devices. A similar determination may be made of one or more other persons specified to be persons to whom the action item could be delegated. In one embodiment, various metrics could be calculated that relate to the capability of a handler to handle the action item, including authorization to do so, availability, cost in time or money required and/or user preferences based either on preferences explicitly provided by the user or preferences derived from feedback relating to past performance of a handler, such as how reliable a particular handler was in taken action on an earlier action item.

Then, at 424, a determination is made as to the costs incurred for each handler to handle the action item, and at 430, a determination is made as to whether there is a handler that can take action on the action item without the cost being too high or the probability of success too low to justify proceeding.

If, at 430, it is determined that there is a handler or handlers that can take action on the action item without the cost being beyond what is deemed justifiable, then one or more handlers are selected at 432. The selection of more than one handler may be prompted by situations such as there being only handlers with a demonstrated low rate of reliability available to handle the action item, in which case, it would not be prudent to rely on just one handler. If the system has sufficient information to handle the action item and the user's profile and/or the rules indicate that the system is the handler that the user would prefer to have handling the action item, then the system can select itself to handle the action item and do so.

Proceeding through 440, 450, 460 and 470, each handler that has been selected is assigned the action item. If at 450, the automated assistant (i.e., the system) has been selected as a handler, then the action item is assigned to the system at 452. If at 460 or at 470, either the user or a person delegated by the user is a selected handler, then a device for contacting the user or the delegated person is selected and used to send a message at 462. Depending on the handlers selected at 432, above, action may be taken by more than one handler, simultaneously, and/or messages may be sent to more than one handler, simultaneously. In a situation such as a cancelled flight, the system may have selected itself as one of the handlers at 432, and may take an initial step in parallel with attempting to contact another handler, such as tentatively booking another flight in such a way that another handler could undo the system's actions if another handler responds sufficiently early.

In selecting a device for use in contacting the user or a person delegated by the user, the current location and activities (i.e., the context) of the user and/or the delegated person may be taken into account. Devices that could be used include, but are not limited to, pagers, cell phones, facsimile transmissions, speech synthesis technology, etc. Once a device has been selected, a countdown marking the passage of time since the attempt at making contact was made may be started, and if the user or delegated person responds before the countdown runs out, then the system either receives their instructions regarding how to handle the action item under their direction or receives and indication that they have handled the action item and that no further action is required. However, if the countdown runs out without a response being received to the attempt at making contact, then this fact may be used in making a new determination of the importance of the event, possibly along with the passage of time where urgency or staleness of the event may be a factor.

If, at 472, all efforts to take action and/or to send messages to handlers other than the system have not resulted in a resolution in response to the action item, then unresolved action item is logged. Subsequently, if there are no more selected handlers to which the action item could be assigned at 440, and there are no more unprocessed action items at 410, then the automated assistant waits at 402 for another event.

The invention has been described in conjunction with the preferred embodiment. It is evident that numerous alternatives, modifications, variations and uses will be apparent to those skilled in the art in light of the foregoing description.

The example embodiments of the present invention are described in the context of an automated assistant with its components organized in a specific configuration, and intended to run on a computer system in support of a single user. However, as those skilled in the art will appreciate, the present invention may be practiced with the various pieces of information on a given user being organized differently than has been described in detail, herein. Specifically, a user's preferences may be combined with the rules, and/or a user's contact information may be combined with a user's PIM information, and so on. Also, a single automated assistant or instance of a piece of automated assistant software may be used to provide automated assistant services to a plurality of users. This plurality of users may be members of a family, employees of a business, or may be individuals with no other connection with each other beyond making use of the same commercial provider of such services. Furthermore, users may also be individuals to whom a user has delegated responsibility for handling particular events, such as a secretary or administrative assistant, or others who use an automated assistant on behalf of another user. Furthermore, the present invention may be practiced using a dedicated automated assistant device that comprises dedicated hardware, as opposed to being practice as automated assistant software designed to be run on any of a number of commonly available computer systems.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Thomas M. Coester, Reg. No. 39,637; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Michael J. Mallie, Reg. No. 36,591; Andre L. Marais, Reg. No. P048,095; Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Judith A. Szepesi, Reg. No. 39,393; Edwin H. Taylor, Reg. No. 25,129; John F. Travis, Reg. No. 43,203; Joseph A. Twarowski, Reg. No. 42,191; Mark C. Van Ness, Reg. No. 39,865; Tom Van Zandt, Reg. No. 43,219; Brent E. Vecchia, Reg. No. P48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney with full power of substitution and revocation, to prosecute this application and to transact all business in the Patent and Trademark Office connected herewith.

### APPENDIX B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

What is claimed is:

1. A method, comprising:
receiving information of an event;
determining the level of importance of the event relative to a first person; and
if the event has a level of importance greater than or equal to a first predetermined threshold, and a level of importance that is below or equal to a second predetermined threshold, then taking action in response to the event without contacting any person.

2. The method of claim 1, wherein determining the level of importance of the event to the first person comprises comparing the subject of the event to a list of subjects of interest to the first person.

3. The method of claim 1, wherein determining the level of importance of the event to the first person comprises referring to information concerning the timing of activities in which at least one person is engaged or will be engaged provided by a calendar.

4. The method of claim 1, wherein determining the level of importance of the event to the first person comprises referring to information concerning the location of activities in which at least one person is engaged or will be engaged provided by a calendar.

5. The method of claim 1, wherein determining the level of importance of the event to the first person comprises referring to information concerning the location of activities in which at least one person is engaged or will be engaged provided by a device carried by said at least one person supplying information concerning said at least one person's current whereabouts.

6. The method of claim 1, wherein determining the level of importance of the event to the first person comprises taking into account a limitation on a way of contacting at least one person arising from where said at least one person is currently located.

7. The method of claim 1, wherein determining the level of importance of the event to the first person comprises referring to information concerning the first person's preferences to determine if the first person would prefer that action be taken on behalf of the first person to respond to the event without contacting any person.

8. The method of claim 1, wherein determining the level of importance of the event to the first person comprises taking into account whether or not an earlier attempt was made to contact at least one person.

9. The method of claim 1, wherein determining the level of importance of the event to the first person comprises referring to information concerning rules specified by the first person concerning circumstances in which the first person will not permit action to be taken without at least one person being contacted.

10. The method of claim 9, wherein referring to rules specified by the first person further comprises referring to information concerning exceptions to those rules.

11. A computer readable medium comprising instructions, which when executed by a processor, causes the processor to:
receive information of an event;
determine the level of importance of the event to a first person; and
if the event has a level of importance greater than or equal to a first predetermined threshold, and a level of importance that is below or equal to a second predetermined threshold, then taking action in response to the event without contacting any person.

12. The computer readable medium of claim 11, wherein determining the level of importance of the event to the first person comprises comparing the subject of the event to a list of subjects of interest to the first person.

13. The computer readable medium of claim 11, wherein determining the level of importance of the event to the first person comprises referring to information concerning the timing of activities in which at least one person is engaged or will be engaged provided by a calendar.

14. The computer readable medium of claim 11, wherein determining the level of importance of the event to the first person comprises referring to information concerning the location of activities in which at least one person is engaged or will be engaged provided by a calendar.

15. The computer readable medium of claim 11, wherein determining the level of importance of the event to the first person comprises referring to information concerning the location of activities in which at least one person is engaged or will be engaged provided by a device carried by said at least one person supplying information concerning said at least one person's current whereabouts.

16. The computer readable medium of claim 11, wherein determining the level of importance of the event to the first person comprises taking into account a limitation on a way of contacting at least one person arising from where said at least one person is currently located.

17. The computer readable medium of claim 11, wherein determining the level of importance of the event to the first person comprises referring to information concerning the first person's preferences to determine if the first person would prefer that action be taken on behalf of the first person to respond to the event without contacting at least one person.

18. The computer readable medium of claim 11, wherein determining the level of importance of the event to the first person comprises taking into account whether or not an earlier attempt was made to contact at least one person.

19. The computer readable medium of claim 11, wherein determining the level of importance of the event to the first person comprises referring to information concerning rules specified by the first person concerning circumstances in which the first person will not permit action to be taken without at least one person being contacted.

20. The computer readable medium of claim 19, wherein referring to rules specified by the first person further comprises referring to information concerning exceptions to those rules.

21. A method, comprising:
receiving information concerning a previous attempt to contact at least one person concerning an event;
determining the level of importance of the event to a first person; and
if the event has a level of importance greater or equal to a first predetermined threshold, and a level of importance below or equal to a second predetermined threshold, then take action in response to the event without making a subsequent attempt to contact any person.

22. The method of claim 21, wherein determining the level of importance of the event to the first person comprises evaluating the effect of the passage of time since a previous attempt to contact at least one person was made on the level of importance of the event.

23. The method of claim 21, wherein determining the level of importance of the event to the first person comprises referring t o information concerning the timing of activities in which at least one person is engaged or will be engaged provided by a calendar.

24. The method of claim 21, wherein determining the level of importance of the event to the first person comprises referring to information concerning the location of activities in which at least one person is engaged or will be engaged provided by a calendar.

25. The method of claim 21, wherein determining the level of importance of the event to the first person comprises referring to information concerning the location of activities in which at least one person is engaged or will be engaged provided by a device carried by said at least one person supplying information concerning said at least one person's current whereabouts.

26. The method of claim 21, wherein determining the level of importance of the event to the first person comprises referring to information concerning the first person's preferences to determine if the first person would prefer that action be taken on behalf of the first person to respond to the event without contacting at least one person.

27. A computer readable medium comprising instructions, which when executed by a processor, causes the processor to:
receive information concerning a previous attempt to contact at least one person concerning an event;
determine the level of importance of the event to a first person; and
if the event has a level of importance greater or equal to a first predetermined threshold, and a level of importance below or equal to a second predetermined threshold, then take action in response to the event without making a subsequent attempt to contact any person.

28. The method of claim 27, wherein determining the level of importance of the event to the first person comprises evaluating the effect of the passage of time since a previous attempt to contact at least one person was made on the level of importance of the event.

29. The method of claim 27, wherein determining the level of importance of the event to the first person comprises referring to information concerning activities in which at least one person is engaged or will be engaged.

30. The method of claim 27, wherein determining the level of importance of the event to the first person comprises referring to information concerning the first person's preferences to determine if the first person would prefer that action be taken on behalf of the first person to respond to the event without contacting at least one person.

31. An apparatus programmed by a first person with information concerning the first person's activities, and configured by a first person to:
receive information concerning an event,
determine the level of importance of the event to the first person, and
if the event has a level of importance greater than or equal to a first predetermined threshold, and a level of importance below or equal to a second predetermined threshold, then take action in response to the event without making an attempt to contact at least one person.

32. The apparatus of claim 31 further programmed by the first person with the first and second thresholds.

33. The apparatus of claim 31 further programmed by the first person with rules indicating when action should always be taken without making an attempt to contact at least one person.

34. An apparatus carried by a first person, configured to communicate with a service provider receiving information concerning an event, allowing the service provider to provide the first person with information concerning the event if the level of importance of the event to the first person is greater than or equal to a first predetermined threshold, and allowing the first person to respond to the information received from the service provider concerning the event.

35. The apparatus of claim 34 comprising means to determine the current whereabouts of the first person and to relay information concerning the whereabouts of the first person to the service provider.
